(19) United States
(12) Patent Application Publication
(10) Pub. No.: US 2007/0027704 A1
(43) Pub. Date: Feb. 1, 2007

(54) System and method for community association violation tracking and processing

(75) Inventors: Tushar V. Patel, Weston, FL (US); Matt Lindenberger, Ft Lauderdale, FL (US)

Correspondence Address: LOTT & FRIEDLAND, P.A., P.O. BOX 141098, CORAL GABLES, FL, 33114-1098, US

(73) Assignee: SIMPLIKATE SYSTEMS, L.L.C.

(21) Appl. No.: 11/192,158

(22) Filed: Jul. 28, 2005

(51) Int. Cl. G06Q 99/00

(52) U.S. Cl. 705/1

(57) ABSTRACT

A computer-implemented method for tracking and processing violations of regulations of a community association comprising the steps of populating a database with information regarding the community association; transferring at least a subset of the information to a handheld computing device; conducting a physical inspection of structures belonging to the community association for compliance with the regulations; and recording the result of said inspection in the handheld computing device.

### TECHNICAL FIELD

The present invention relates generally to community association management and enforcement of the rules and regulations that govern the aesthetics, noise and use of real estate within a community association and enforced by a community association management company. More specifically, the present invention discloses a system and method that permits managers of multiple community associations to seamlessly and accurately observe, record, report, follow-up and collaborate with multiple community association boards in enforcing compliance by residents of the covenants of their respective associations in a timely manner.

### BACKGROUND OF THE INVENTION

A community association can generally be described as an owners group, whether in a condominium, townhouse or single family subdivision, that establishes general guidelines for the operation of the community, as well as its standards, including rules and regulations governing the aesthetics, noise and use of real estate within the community. A community association derives its authority to enforce community regulations from covenants that must be accepted by property owners upon purchase of the property in question.

In the United States, the concept of community associations has been developing over the last 150 years. As with many other concepts borrowed from other countries, community associations have evolved into uniquely American institutions. There are presently an estimated 260,000 Community Associations representing 20,000,000 homes in the United States.

Community associations are generally governed by volunteer boards composed mostly of residents of the community having widely varying backgrounds. Virtually all community association boards eventually retain a property management company (“PMC”) to perform the core services required in order for the communities to succeed in preserving their value. Enforcing community regulations is usually the most contentious of these services as it places the board in an adversarial position with respect to the residents they serve. In this context, PMC acts simultaneously as the principal enforcement mechanism for the board and as a mediator/facilitator in ensuring that the community regulations are followed. These dual roles place intense pressure on the PMC to maintain accurate records of any violations and to diligently follow-up on enforcement letters and other actions.

In the United States, more that 1.2 million volunteers serve on community association boards with another 300,000 participating as committee members. There are 230,000 annual association meetings with democratically conducted elections and another nearly 1.5 million regular board meetings each year in which owners debate and shape their community's future. To assist the board, there are over 500,000 committee meetings during each fiscal year. Collectively, community association boards supervise the collection of over $32 billion in annual assessments and maintain investment accounts of another $35 billion for the long-term maintenance and replacement of commonly held property.

Community associations govern nearly 50 million individuals in homes that have an estimated resale value of over $2 trillion dollars. These individuals spend annually over $25 billion on internal home improvements and an estimated $85 billion on mortgage interest and real estate taxes.

PMCs provide varying degrees of service to community associations ranging from complete management of every aspect of community life to very circumscribed board directed activity. In the performance of such duties, any given PMC may, for fiscal efficiency, utilize a single manager to manage several communities within a “portfolio.”

Since boards are usually elected annually, PMC contracts with particular communities are normally reviewed and subject to renewal on an annual basis. Accordingly, manager's portfolios are subject to change and can vary from month to month as management companies reassign managers between communities that choose to switch management companies for reasons related to performance of a particular manager.

Each board is tasked with managing the enforcement of the regulations of their association by supervising and collaborating with the manager assigned by the property management company. Due to the voluntary nature of boards and the relatively transient nature of the managers that enforce the rules of the association, it is often difficult to establish an accurate understanding of what is and isn't permissible under the regulations. This is so even with the existence of legally binding covenants because different board may have different interpretations, which are subject to change over time, of identical covenant language.

Covenants setting forth community regulations are usually several hundred pages long and are rarely read in detail by homeowners. The main purpose of such a covenant is to act as a “constitution” for the community for acceptable use, aesthetics and other issues affecting the community.

Often (about 15% of the time), homeowners will violate the regulations in ways that are deemed detrimental to the aesthetics or quality of life in the community. Examples of such violations include parking a boat in front of their yard; painting a house a color not approved by the board; leaving trash in a common area; etc.

Property managers are regularly dispatched by PMCs at the behest of the boards that employ them, to inspect communities for compliance with the regulations. Enforcement requires extensive knowledge of the covenants and the rules and procedures to enforce them. Further, it requires accurate data as to who the offending homeowners are and their contact information for proper notification of violations.

Boards and property managers must enforce the community regulations as violations directly impact the value of the homes in the community. Moreover, a violation may have safety implications that could create a legal liability for the community. In addition, aesthetic violations degrade the quality of life within the community which has a tendency to lower the values of all homes, not just those in violation.

In order to manage these responsibilities and to coordinate with PMCs, boards often appoint committees to do nothing but adjudicate violations of the regulations which have been noted by the PMC. Such committees require up-to-date knowledge about pending violations and the history of the violating party to adjudicate a fair action within the guidelines set forth by the regulations.

Violating homeowners often resent fellow homeowners (board members elected by the community) notifying them of a violation of the community regulations. This places additional pressure on the PMC to deliver accurate and verifiable information to the board which it can, in turn, show the homeowner in order to establish irrefutable proof of a violation and defuse a potentially contentious situation.

Residents who violate the regulations usually deny the doing so or state they were unaware of the regulation concerned. This requires the PMC and manager to carefully document the existence of the violation in question and the existence of past violations evidencing knowledge of the regulation by the homeowner. Such activity is extremely time consuming and difficult to conduct accurately without careful recordkeeping and access to the actual documentation obtained by the property manager during inspection of the property.

In the event a violation is not remedied, community associations are empowered by their respective covenants to initiate foreclosure proceedings through an attorney. Such attorneys usually require evidence of the offense and proof that the covenants and the follow up procedures to enforce the covenants have been followed precisely.

The present invention addresses these problems by providing a completely integrated system and method for recording, reporting, acting upon, cataloging, and making accessible, notices of community regulation violations and evidence appurtenant thereto.

Previous attempts at integrated systems and/or methods, or components thereto, related to property management are described in the publications described in detail below:

United States Patent Application Publication No. US 2002/0138289 to Thielges et al. describes a network-based system and method for managing property where events such as service requests or maintenance reminders are created, tracked and managed. The system may be internet-accessible and require user ID's. The property manager, tenants and vendors have access to the system. Typically, the tenants initiate a service request and the property manager then logs onto the system and initiates a request for quotation from selected vendors or, alternatively, the property manager may forward the service request directly to a specific vendor.

United States Patent Application Publication No. US2002/0062218 to Pianin describes a method and system for providing property management services in an on-line computing environment. The property management environment improves commercial real estate transactions by providing a web site that can serve as a commercial real estate professional's workspace to obtain industry specific content, use support tools, benchmark performance, and access vendors in a personalized environment. The system allows users to select, contract, and obtain property management services including site appraisal, engineering and environmental services.

European Patent Application No. EP 1318469 to Shike et al. describes a rental system that manages and operates all rental properties. The rental system is designed to manage construction vehicles and keeps track of the vehicles current position, rental state, the maintenance state of the construction vehicle, and provides such information to the server at the branch office. The information on the system can be obtained by a terminal computer at the branch office, portable telephones, and PDA's. The system allows for the office to keep track of rental orders, transfer, and maintenance of the vehicles.

United States Patent Application Publication No. US2003/0078897 to Florance et al. describes a system and method for collection, distribution, and use of information in connection with commercial real estate and a web-based marketplace that facilitates the efficient and secure buying, selling, and leasing of commercial properties. The tools available include a survey tool, a commercial real estate transaction tool, a tour scheduling tool, an activity summary tool, and a tool for analyzing commercial real estate data.

United States Patent Application Publication No. US2003/0093289 to Thomley et al. describes a computer database system that reports and collects rent payment history for renters, leases, and lease events. Property managers report lease events to the central database. The database keeps track of late payments, pet fees, deposits, and damage penalties. The database can then be accessed by property managers, credit bureaus, mortgage companies, etc.

United States Patent Application Publication No. US2002/0040335 to De Veux et al. describes a maintenance fee recovery system to be used by time share owners. Essentially, the buyer of a time share is given an opportunity to pre-pay his maintenance fees to the homeowners' association upon his purchase of the property. The incentive to pre-pay is typically a discount where a seven year payment is agreed to cover a ten year span.

United States Patent Application Publication No. US2002/0169622 to Estridge describes a process for the development of real estate comprising the steps of separating private easements for the provision of common services in a developed community and establishing decision making authority regarding control over these private easements in a single privately owned entity to identify and contract with various service providers. Thus the private entity would provide common services to the developed community from a single source which obtains the particular services from one or more other service providers.

United States Patent Application Publication No. US2002/0046144 to Graff describes a system and method for computing to support decomposing property into separately valued components. The system uses at least two components, for example, an estate for years and a remainder interest. The system applies respective values for each component, where the values reflect taxation for the components. The respective values are turned into an illustration of the computed respective prices. The property can be real estate or tax-exempt securities.

Unites States Patent Application Publication No. US2002/0087349 to Wong describes a system and method for increasing perceived value of property to tenants. The system provides property to tenants, gathering information about tenants, negotiating with vendors for tenants' needs using tenants' aggregated purchasing power.

United States Patent Application Publication No. US 2001/0039496 to Good et al. relates to a method for managing real estate brokerage referrals. An internet broker computer system stores a database of real estate rental listings to be reviewed by potential tenants. The broker computer system automatically generates an online brokerage referral fee agreement specific to the potential tenant and apartment complex. The tenant then presents the brokerage referral fee agreement to the apartment complex.

None of the systems, methods or devices described in the above art disclose a completely integrated system and method for recording, reporting, acting upon, cataloging, and making accessible, notices of community regulation violations and evidence appurtenant thereto.

In addition, none of the systems, methods or devices described in the above art disclose an integrated system which allows property managers to easily conduct property inspections with information regarding relevant regulations readily available and with the ability to enter information regarding violations into a central database in real time or near real time.

In addition, none of the systems, methods or devices described in the above art disclose a system that allows a property manager to have all the information needed, including community regulations, identification of residents and violation histories, instantly available at the time property inspections are conducted.

Therefore, there is a need in the prior art to provide a system and method to enable a PMC to allow property managers to manage multiple communities without requiring them to individually learn the regulations of any particular community.

There is a further need in the art to provide a system and method to enable a property manager to conduct violation inspections by following an automated procedure that guides the property manager through a community and provides the specific regulations applicable to said community.

There is a further need in the art to provide a system and method to alert community residents in an efficient and timely manner when they are in violation of a community regulation and to advise options available and steps needed to remedy the violation.

There is a further need in the art to provide a system and method to share community regulation violation information, including the history of violations for a particular resident or property, in real time or near real time with boards tasked to adjudicate violations.

There is a further need in the art to provide a system and method to provide irrefutable proof that a violation occurred at a particular time and date and that proper notification took place in a timely manner consistent with the covenants of the community.

There is a further need in the art to provide a system and method to provide multiple reminders and options to the manager to follow up on violation notifications in accordance with community covenants, property manager's judgment and experience, and a board's adjudicative measures.

There is a further need in the art to provide a system and method that allows a property manager to have all the information needed, including community regulations, identification of residents and violation histories, instantly available at the time property inspections are conducted.

There is a further need in the art to provide a system and method that allows a property manager to properly document a property inspection with accurate time and date stamps of an inspection, photographs of evidence of a violation and other relevant information applicable to the inspection.

There is a further need in the art to provide a system and method that allows a PMC to efficiently and seamlessly incorporate all inspection related information into a central repository database that can be accessed by all interested parties in real time or near real time.

### SUMMARY OF THE INVENTION

The subject invention resolves the above-described needs and problems by providing a completely integrated system and method for recording, reporting, acting upon, cataloging, and making accessible, notices of community regulation violations and evidence appurtenant thereto.

The principal features of the disclosed system and method include a set of relational databases which include information about particular communities, properties located within said communities, regulations applicable to said communities, property managers assigned to each community, records of violations issued within said communities, digitized photographic evidence related to regulation violations, and other information needed by the PMC to adequately perform its functions.

The databases described above are housed within a central server which is itself part of a distributed computing environment. The databases are available to users of the distributed computing environment via standard means such as attached terminals or remote terminals connected through an electronic communication network such as the Internet.

Different categories of users have different ways to interface with the database in accordance with their needs. Board members, for example, have the ability to access violation histories for the communities they are elected to represent and administer and generate reports. Property manager users, for example, have the ability to access information for all the communities that are assigned to, including community regulations, violations for each community in need of follow-up, names and addresses of community residents, etc. Administrative users have the ability to access administrative information such as the data for communities serviced, the property manager assigned to a community, the various user accounts in the system, etc.

The principal method for input of information into the databases is via synchronization of data from a personal digital assistant (PDA) device, in which a property manager has entered information during an inspection. Prior to a typical inspection run, a property manager will download all information needed for the inspection to his PDA. The information includes, for example, the addresses of all properties to be inspected, data regarding residents of the properties, violation histories for the properties in question and the regulations for the community or communities where those properties are located.

Specialized software within the PDA generates a route to be followed by the property manager which includes all properties to be inspected. Upon arrival to a property, the property manager can display available information for the property in question, including, for example, the identity of its residents, its violation history, community regulations which apply to the property, and pending repairs resulting from previous notifications of violations.

The property manager can then inspect the property for violations or verify that repairs pending from prior violation notifications have been sent to the property owner. The property manager's PDA is equipped with a touch screen where data can be entered by the property manager as well as a digital camera or audio/voice memo recording device which can be used to document conditions at the property in question.

Once a report of violation, and any accompanying documentation, is entered by the property manager into his PDA, he can now move on to the next property on his route. At the conclusion of the route, the property manager returns to his office where he can connect the PDA to a computer terminal to upload the newly entered information into the appropriate database. Alternatively, the data can be uploaded wirelessly in real time to the database after the property manager concludes his inspection of each property. Once the information has been uploaded to the databases, it is immediately available for access by users.

Users can utilize the information in a variety of ways. For example, users can use specialized front end database applications to generate reports of outstanding violations, to automatically generate letters to residents notifying them of new violations or to automatically generate work orders to contractors for repairs which have not been performed by homeowners despite notification of violations.

Accordingly, it is an object of the present invention to provide a completely integrated system and method for recording, reporting, acting upon, cataloging, and making accessible, notices of community regulation violations and evidence appurtenant thereto.

It is an additional object of the present invention to provide an integrated system which allows property managers to easily conduct property inspections with information regarding relevant regulations readily available and with the ability to enter information regarding violations into a central database in real time or near real time.

It is an additional object of the present invention to provide a system that allows a property manager to have all the information needed, including community regulations, identification of residents and violation histories, instantly available at the time property inspections are conducted.

It is an additional object of the present invention to provide a system and method to enable a PMC to allow property managers to manage multiple communities without requiring them to individually learn the regulations of any particular community.

It is an additional object of the present invention to provide a system and method to enable a property manager to conduct violation inspections by following an automated procedure that guides the property manager through a community and provides the specific regulations applicable to said community.

It is an additional object of the present invention to provide a system and method to alert community residents in an efficient and timely manner when they are in violation of a community regulation and to advise options available and steps needed to remedy the violation.

It is an additional object of the present invention to provide a system and method to share community regulation violation information, including the history of violations for a particular resident or property, in real time or near real time with boards tasked to adjudicate violations.

It is an additional object of the present invention to provide a system and method to provide irrefutable proof that a violation occurred at a particular time and date and that proper notification took place in a timely manner consistent with the covenants of the community.

It is an additional object of the present invention to provide a system and method to provide multiple reminders and options to the manager to follow up on violation notifications in accordance with community covenants, property manager's judgment and experience, and a board's adjudicative measures.

It is an additional object of the present invention to provide a system and method that allows a property manager to have all the information needed, including community regulations, identification of residents and violation histories, instantly available at the time property inspections are conducted.

It is an additional object of the present invention to provide a system and method that allows a property manager to properly document a property inspection with accurate time and date stamps of an inspection, photographs of evidence of a violation and other relevant information applicable to the inspection.

It is an additional object of the present invention to provide a system and method that allows a PMC to efficiently and seamlessly incorporate all inspection related information into a central repository database that can be accessed by all interested parties in real time or near real time.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a schematic block diagram which shows the interrelationship between different hardware components of the system.

FIG. 2 is an illustration of the common components of the basic interface utilized for accessing various functions of the preferred embodiment of the present invention.

FIGS. 3A-3D are illustrations of the user interface for accessing administrative functions of the preferred embodiment of the present invention.

FIGS. 4A-4I are illustrations of the user interface for accessing violation, work order and inspection entry functions of the preferred embodiment of the present invention.

### DETAILED DESCRIPTION OF THE PREFERRED EMBODIMENT

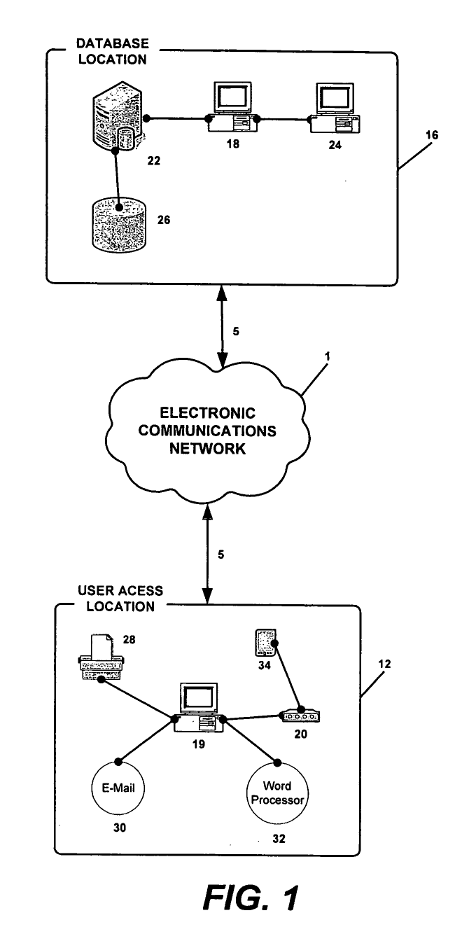

Referring initially to FIG. 1 of the drawings, in which like numerals indicate like elements throughout the several figures, the environment in a preferred embodiment of the present invention includes at least one User Access Location 12 and at least one Database Location 16. It is envisioned at present that each of the aforementioned locations will be housed in a separate physical geographic location, however, a separate geographic presence for each location is not necessary for the present invention to function.

Each of the locations is equipped with means to communicate via electronic means 5 to an electronic communications network (“ECN”) 1, such as the Internet. In this fashion, each of the locations is capable of electronic communications through the ECN with any other location in the system. The communications means 5 can consist of one or more of the many traditional electronic communication means such as DSL, internet cable connections, analog modems, wireless links, and the like.

The database location is equipped with at least one database server 22, at least one internet server 24, and, optionally, one or more personal computers (PC). A PC should be understood to minimally include the standard components that normally comprise a computer such as a central processing unit, mass storage devices, random access memory, a display, and input means such as a keyboard and/or a mouse. The database server 22, internet server 24 and personal computer 18 all interoperate in a locally networked environment such as a LAN. Although the database server 22, internet server 24 and personal computer terminal 18 have been described as separate components for the sake of clarity, it is envisioned that they could be integrated into a single hardware component.

The database server 22 is utilized to manage and administer a central database where all of the community association information is stored and made available for use by the various types of users of the system. The internet server 24 is used to dynamically generate web pages which are the preferred interface for the various users of the system to access and enter information into the database 22. The web pages generated by the internet server 24 are dynamically linked to the database server 22 so as to allow said web pages to (a) display information contained in the database 26; (b) enter new information in the database 26; (c) modify information in the database 26; and (d) make information from the database 26 available for use by applications, such as word processors and e-mail clients, residing in the various users' environments. For this purpose, the internet server 24 utilizes technologies, such as application server pages (ASP) and the like, which are well known in the art. The optional personal computer terminals can be utilized to provide direct access to the internet server 24 and database server 22 in case of failure of the ECN 1.

Each User Access Location 12 is equipped with at least one PC 19 with means to access the ECN 1 and an internet browser such as, for example, Microsoft Internet Explorer, Netscape Navigator or Mozilla Firefox, which is capable of displaying and interfacing with the web pages generated by the internet server 24. The User Access Location is also equipped with additional hardware which may be necessary depending on the type of user that will be accessing the system. Specifically, the User Access Location may be equipped with a printer 28 to generate letters or reports. The User Access Location may also be equipped with a docking station 20, or other means to enable the personal computer to exchange information with a user's PDA 34 or other handheld data entry means. Finally, the PC 20 may also be equipped with additional software, such as a word processing application, a spreadsheet application, and an e-mail client, which can perform various tasks and generate reports and letters based on the information contained in the database 26.

As described previously, there are various types of users that can be given different levels of access and be permitted to conduct different types of tasks in connection with the described system. The two main types of users are Administrators and Property Managers.

Administrators, as their name implies, are mainly concerned with administration and maintenance of the system. The principal tasks that Administrators are charged with are: (a) setting up in the database 26 the different community associations to be managed by the system; (b) entering information regarding individual properties, homeowners and residents for each such community association; (c) setting up of the various users, including Property Managers that will access the database 26; and (c) assigning various levels of access rights to users for particular community associations in the database 26.

Property Managers are the class of users who interface with the system on a day to day basis to perform the various tasks related to management of the community associations and properties. These tasks are principally comprised of: (a) conducting ad documenting inspections of properties for compliance with community rules and regulations; (b) creation of violation records for properties that fail to comply with such rules and regulations; (c) notifications to community officials, management boards, homeowners and residents of such violations; (d) issuance of work orders for work orders to contractors for repairs which have not been performed by homeowners despite notification of violations; and (e) preparation of reports detailing inspection, violation and work order activity for a given time period, community association and/or property.

Other types of users optionally include Board Members and Residents. Board Members and Residents will generally only be given access to view, but not change, information contained in the database 26. Generally speaking, Board Members will enjoy rights to view reports, violations, work orders and inspection records for all of the properties within the community association they represent. Residents, on the other hand, are given access to essentially the same information but only for the individual property, or properties, they own. In addition to this, Board Members may be provided with additional tools to communicate with Property Managers or Administrators regarding system maintenance or substantive tasks to be completed for the purpose of managing the community association.

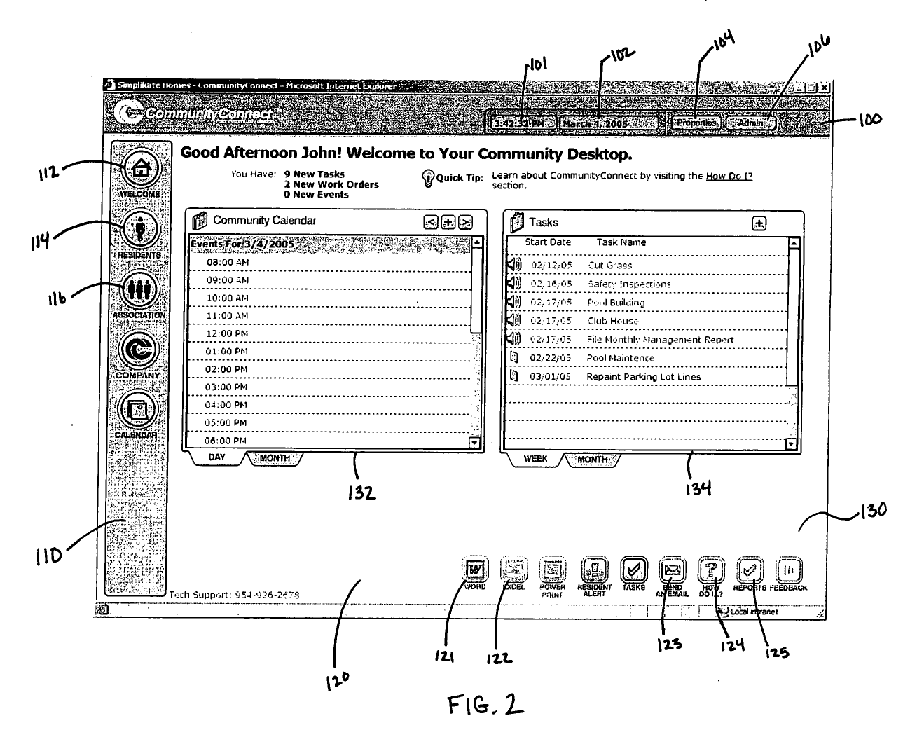

Referring next to FIG. 2, shown is an illustration of a computer screen display with the common components of the basic interface utilized for accessing various functions of the preferred embodiment of the present invention. As discussed previously, this interface may be accessed by a user of the system by simply entering a web address in the web browser of their choice installed at the User Access Location PC 19. The web address directs the browser to download pages from the internet server 24 at the Database Location 16.

The common elements shown in FIG. 2 are the same for all users regardless of their type. At the top edge of the screen is a top toolbar 100. At the left edge of the screen is a left toolbar 110. At the bottom edge of the screen is a bottom toolbar 120. In the middle of the screen is the data area 130.

The top toolbar 100 displays the time 101 and date 102 and includes buttons to select administrative functions 104 and property selection 106. By clicking on the administrative functions button 104, the data area 130 is populated with an interface to system administrative functions which will be addressed further below. By clicking on the property selection button 106, users are presented in the data area 130 with a selectable list of all community associations to which they are assigned.

The left toolbar 110, includes buttons for a residents screen 114, an association screen 116, and a button to display the user's “welcome” screen 112. When the residents screen button 114 is selected, the data area 130 is populated with a list of all residents for the currently selected community association. When the association screen button 116 is selected, the data area 130 is populated with an interface to the various functions that the user may perform in connection with management of the community association. For example, upon selecting the association screen button 116, a Property Manager will be presented with the interface to, among other things, enter inspection requests, issue work orders, issue violations, and e-mail notifications with regard to a particular home located in the currently selected community association. Residents, on the other hand, are only shown a list of violations, inspection records and work orders related to their own property. Board Members may be presented with information for violations, inspection records and work orders related to the entire community association they represent.

The bottom toolbar 120 includes buttons linking to external applications such as a word processor 121 to generate letters, a spreadsheet application 122, an e-mail client 123, and a “help” system 124 to provide assistance to the user in utilizing the system. Also included is a button for opening the report generation interface 125.

The data area 130 shown in FIG. 2 is the opening or “welcome” screen of the system that greets the user upon logging in to the system. A user signs into the system by entering a predetermined username and password assigned by an Administrator. The information displayed on the welcome screen varies depending on the type of user that is logged in. However, the screen will generally include an area to show the user's upcoming calendar of events 132 in relation to properties he manages as well as a list of tasks, or “to dos”, 134 to act as reminders to the user.

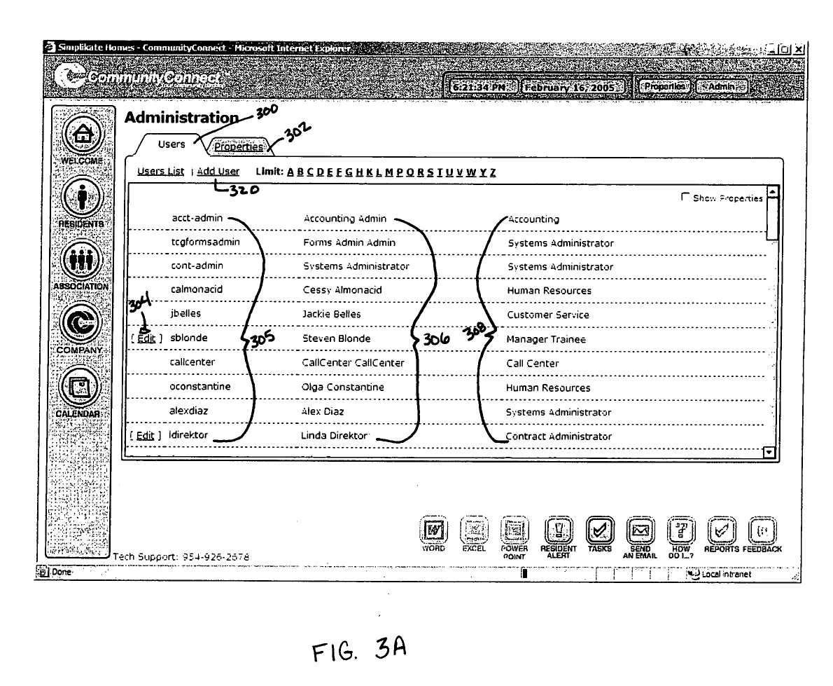

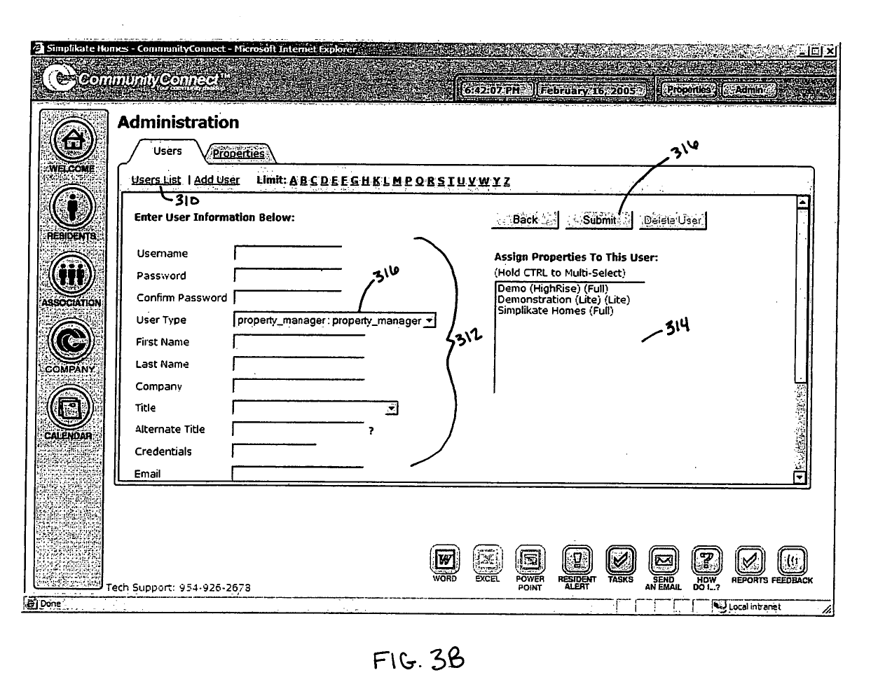

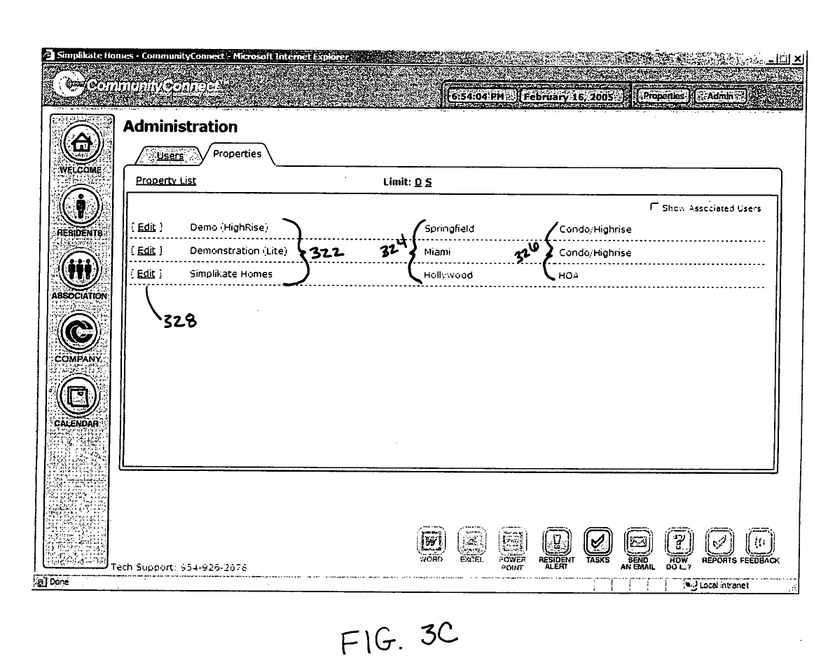

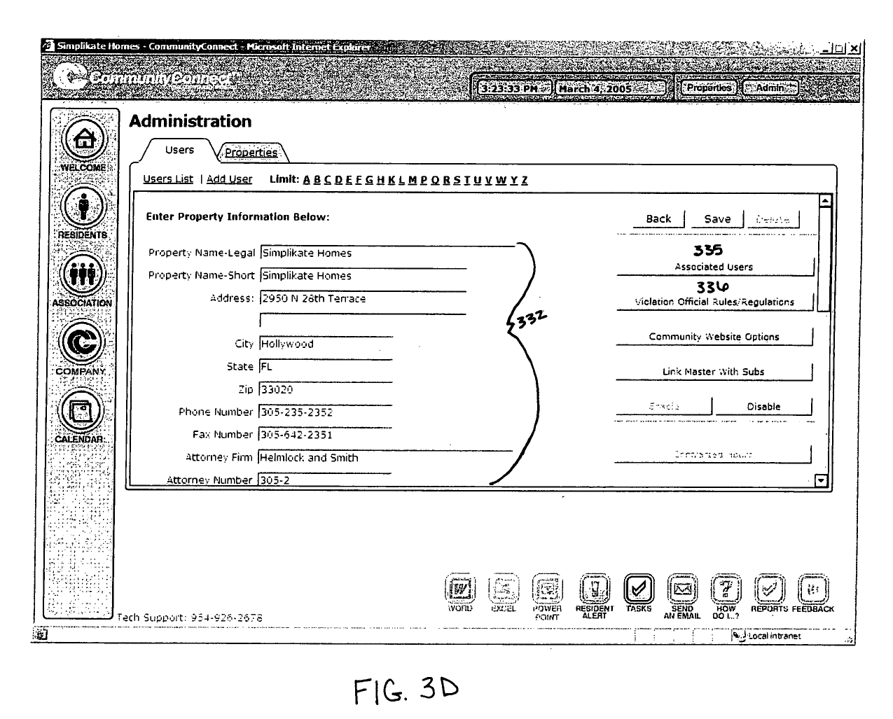

Referring next to FIGS. 3A-3D shown are illustrations of the user interface for accessing administrative functions of the preferred embodiment of the present invention. Shown in FIG. 3A is the screen that is displayed when an Administrator presses the administrative functions button 106. Users other than-Administrators that select the administrative functions button 106 are denied access to the administrative interface. Alternatively, users with more limited rights that an Administrator may be given partial access to the administrative interface to allow changes to personal data.

The initial administrative functions screen has two tabs to select between user administration 300 and property administration 302. The user administration screen includes three columns of data 305, 306, 308. The leftmost column 305 lists the username assigned to each user, the middle column 306 displays the full name of each user, and the rightmost column 308 displays the types of users in the system. If a particular username has an [Edit] label 304 next to it, then the user information is editable by the Administrator that is accessing the system. If the Administrator selects the [Edit] label 304 or the “Add User” label 320, the user edit screen appears in the data area 130.

The user edit screen is shown in FIG. 3B. In this screen, the Administrator may enter user data in the input fields 312. This data consists of information such as username, password, first and last names, e-mail addresses, etc. The user input fields 312 also include a means 316 to assign each user a particular type depending on the role they play in the organization. Finally, the user edit screen includes a section 314 for assigning the newly created or edited user to a particular community association property. Once all of the information has been entered, pressing the “submit” button 316 saves the information to the appropriate tables in the database 26 and establishes all of the links necessary between said tables. Pressing the “Users List” label 310 returns the user to the initial user administration screen (FIG. 3A)

The property administration screen, shown in FIG. 3C, is reached by selecting the property administration tab 302 form the initial administration screen. In this screen, the user is presented with a list of community association properties that are available for management by the system. The leftmost column 322 lists the property names, the middle column 324 lists the general location of each property, and the rightmost column 326 lists the type of property. If an [Edit] label 328 is present next to the name of a property, the user may select it and enter the property detail screen.

The property detail screen is shown in FIG. 3D. From this screen, the user can input or edit information about a particular community association property in the property input fields 332. The user can also perform various functions by selecting the property detail buttons 334 on the right portion of the screen. Specifically, the user can select the “Associated Users” button 335 to show all users that have been associated with the community association property being edited. The user can also select the “Violations/Rules” button 336 to view a listing of violations issued for homes located within the community association property being edited as well as the homeowner rules and regulations for said community association property. Since the rules and regulations can are already incorporated into the information available to the user, they can be readily quoted in reports or letters generated by the user without need for the user to memorize or have intimate knowledge of same.

The system also provides a similar interface, not illustrated for purposes of brevity, that allows an Administrator to create records for homes or “units” within each community association property in the system. Each unit is designated with information such as the names of its occupants or residents, the physical address, telephone numbers, email addresses and the like.

Once the user and community association property data information has been entered into the database 26 by an Administrator, the system is ready to accept inspection, violation and work order data from Property Managers. There are two ways in which inspection, violation and work order data may be entered by a Property Manager. The first method is by interfacing with a PC 18 at a User Access Location 12. The second, and preferred method, is by interfacing with a PDA 34 or other handheld device while “in the field” and then synchronizing the field data gathered through the PDA 34 with the database 26 at a User Access Location 12 by means of a docking station 20. Alternatively, depending on the capabilities of the PDA, it may be possible to synchronize the data wirelessly without a docking station 20. It should be understood that while the illustrations below apply to the use of a PDA 34, a similar interface is available to a Property Manager to enter inspection, violation and work order data directly at a PC 19 in a User Access Location 12.

In a typical scenario, a Property Manager would periodically be scheduled to visit a community association property to ascertain whether the residents are in compliance. In preparation for such a visit, the Property Manager would synchronize his PDA 34 (either wirelessly or via a docking station 20) at a PC 19 to download data from the database 26 for the relevant community association property to his PDA 34. Once the data has been downloaded to the PDA, the Property Manager can travel to the site and begin visiting homes.

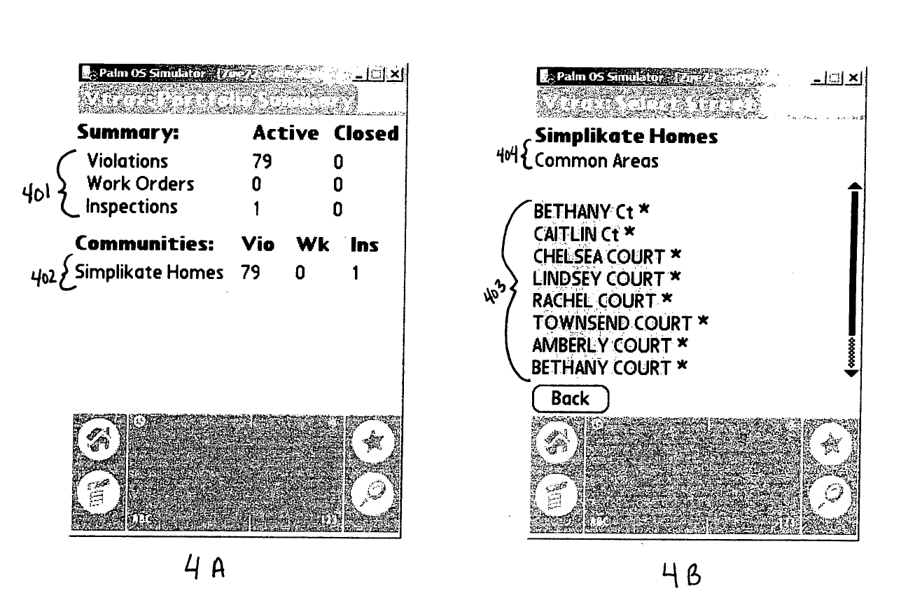

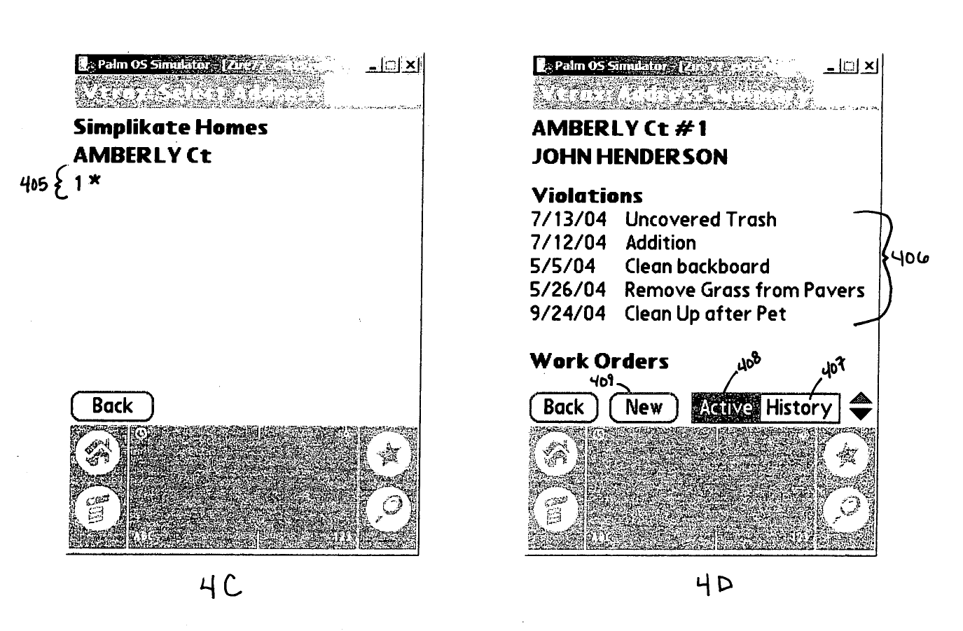

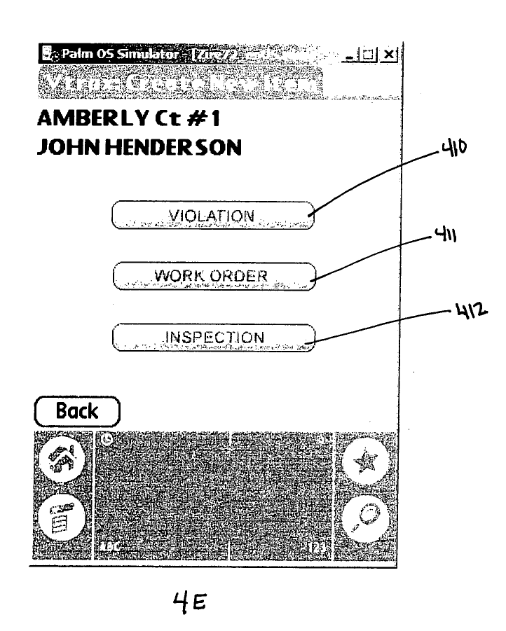

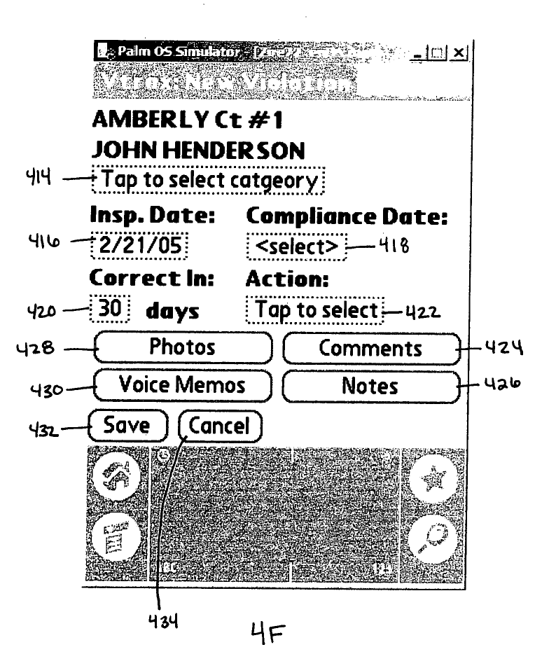

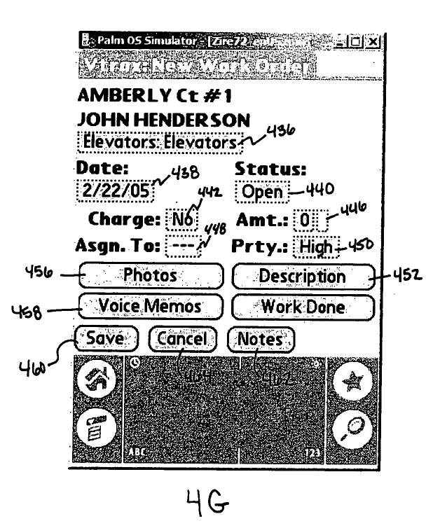

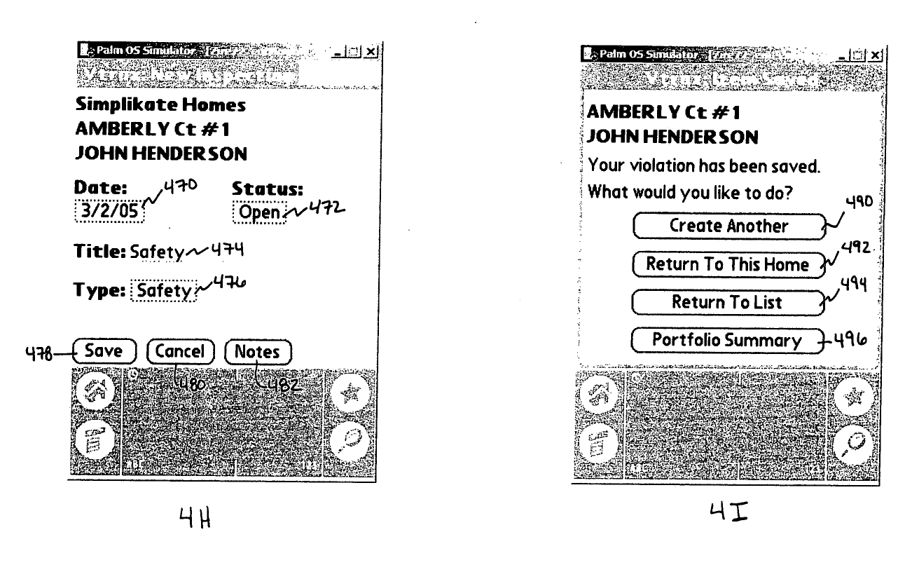

Referring now to FIGS. 4A-4I, shown are illustrations of the PDA user interface for accessing violation, work order and inspection entry functions of the preferred embodiment of the present invention. After logging on to the PDA and beginning execution of the system software, the Property Manager is presented with a “Portfolio Summary” screen (FIG. 4A) which shows the total number of violations, work orders and inspections 401 belonging to the Property Manager that are stored on the PDA. Also shown is a list of community association properties 402 which are also stored on the PDA. Upon selection of a community association property, the screen displays (FIG. 4B) a list of all streets 403 and common areas 404 located within the selected property. The Property Manager can then select the street for a home he is visiting and is the presented (FIG. 4C) with a list of numbers 405 corresponding to addresses for the homes located on the selected street. From this list, the Property Manager can select the particular home he is visiting. In this list, a special character (such as an asterisk) can be appended to the street number to indicate that the particular address has an existing open violation, report, inspection, work order, or other item.

After a home has been selected, the screen changes to an “Address Summary” screen (FIG. 4D) which lists all work orders, violations and inspections 406 previously entered for the selected home. The Property Manager can select to display pending work orders, inspections or violations by selecting the “Active” button 408. The Property Manager can select to display closed work orders, inspections or violations by selecting the “History” button 408. If a particular violation, work order or inspection is selected from the list, the screen changes to display all relevant information for the violation, work order or inspection. If the Property Manager wishes to enter a new violation, work order or inspection he can select the “New” button 409 and will then be shown the “Create New Item” screen (FIG. 4E). From this screen, the Property Manager can select either the “Violation” 410, “Work Order” 411, or “Inspection” 412 buttons depending on which item he wishes to add to the database.

If the Property Manager selects the “Violation” button 410, the screen display changes to the “New Violation” entry screen (FIG. 4F). From this screen, the Property Manager can enter the following information: (a) the type of violation 414; (b) the date the violation was noted by the Property Manager 416; (c) the date when the violation must be corrected by 418, alternatively this date can be automatically calculated and entered for the Property Manager by designating the number of days 420 from the date of the violation 414; and (d) the action that is to be taken by the Property Manager 422 (i.e., issue 1^{st} notice, issue 2^{nd} notice, etc) in connection with the new violation. The information above can be entered as free text by the Property Manager utilizing the PDA's touch screen, keyboard or other input mechanism. Alternatively, where appropriate and desired, the information can be selected from a “drop down” list of available choices.

In connection with a new violation, the Property Manager can add notes or comments by selecting the appropriate button 424, 426. Also, if the PDA is equipped with a photo camera, the Property Manager can attach one or more photographs of the violation by selecting the “Photos” button 428. Finally, if the PDA is equipped with voice recording capabilities, the Property Manager can record and attach an audio file to the violation by selecting the “Voice Memos” button 430. Once the Property Manager has entered all of the desired information in the “New Violation” entry screen, he can select the “Save” button 432 to commit the information to memory and incorporate same into the PDA's internal database. If the Property Manages wishes to discard the information he can select the “Cancel” button 434.

Referring back to the “Create New Item” screen (FIG. 4E), if the Property Manager selects the “Work Order” button 411, the screen display changes to the “New Work Order” entry screen (FIG. 4G). From this screen, the Property Manager can enter the following information: (a) the type of work order 436; (b) the date the work order is being issued by the Property Manager 438; (c) the status of the work order 440 (i.e., whether the order has been completed or remains open); (d) whether the homeowner or someone lese is to be charged for the cost of the work to be performed 442; (e) how much should be charged for the work to be performed 446; (f) the person, persons or companies that should be assigned to the work order 448; and (g) the priority level to be assigned to the work order 450 The information above can be entered as free text by the Property Manager utilizing the PDA's touch screen, keyboard or other input mechanism. Alternatively, where appropriate and desired, the information can be selected from a “drop down” list of available choices.

In connection with a new work order, the Property Manager can add notes or a description of the work to be performed by selecting the “Notes” button 462 or the “Description” button 452. Also, if the PDA is equipped with a photo camera, the Property Manager can attach one or more photographs of the work order location by selecting the “Photos” button 456. If the PDA is equipped with voice recording capabilities, the Property Manager can record and attach an audio file to the work order by selecting the “Voice Memos” button 458. Once the Property Manager has entered all of the desired information in the “New Work Order” entry screen, he can select the “Save” button 460 to commit the information to memory and incorporate same into the PDA's internal database. If the Property Manages wishes to discard the information he can select the “Cancel” button 464.

Referring back to the “Create New Item” screen (FIG. 4E), if the Property Manager selects the “Inspection” button 412, the screen display changes to the “New Inspection” entry screen (FIG. 4H). From this screen, the Property Manager can enter the following information: (a) the type of inspection to be performed on the selected home 476; (b) the date the inspection request is being issued by the Property Manager 470; (c) the status of the inspection 472 (i.e., whether the inspection has been completed or remains open); and (d) a descriptive title for the inspection 474. The information above can be entered as free text by the Property Manager utilizing the PDA's touch screen, keyboard or other input mechanism. Alternatively, where appropriate and desired, the information can be selected from a “drop down” list of available choices.

In connection with a new inspection, the Property Manager can add notes or a description of the inspection to be performed by selecting the “Notes” button 482. Once the Property Manager has entered all of the desired information in the “New Inspection” entry screen, he can select the “Save” button 478 to commit the information to memory and incorporate same into the PDA's internal database. If the Property Manages wishes to discard the information he can select the “Cancel” button 480.

Upon saving a new violation, work order, or inspection, the screen display changes to the “Item Saved” screen (FIG. 41). From this screen the Property Manager can select to create another item of the same type 490, return to the “Address Summary” screen (FIG. 4D) or return to the “Portfolio Summary” screen (FIG. 4A).

After the Property Manager visits the various homes in the community association property and has entered all violations, work orders and inspections for said homes, he can return to the User Access Location 12 where he once again can synchronize his PDA 34 (either wirelessly or via a docking station 20) at a PC 19 to upload the new data to the database 26.

Once all of the new data has been uploaded to the database 26, it is available for use and display by all users of the system including the Property Manager, Board Members, Residents and Administrators. Depending on the type of data and the preferences selected by the Administrators and Property Manager, the data may trigger automated events.

For example, any new violations uploaded into the database 34, could automatically trigger the generation of e-mail or paper correspondence to the concerned homeowner advising of the violation and requesting that it be remedied before a given date. The e-mail or paper correspondence would include all pertinent data, including photographs and a description of the violation. A new violation could also automatically generate a notification to the concerned community association board and could automatically schedule a hearing date for the violation depending on the rules and regulations for the association which are programmed into the system.

In another example, any new work orders could automatically generate paper or e-mail work requests to the appropriate contractor to perform necessary work. A detailed work order could be generated and automatically mailed, including photographs and detailed notes, based on the information entered by the Property Manager in the field.

Accordingly, it will be understood that the preferred embodiment of the present invention has been disclosed by way of example and that other modifications and alterations may occur to those skilled in the art without departing from the scope and spirit of the appended claims.

We claim:

1. A computer-implemented method for tracking and processing violations of regulations of a community association comprising the steps of:
populating a database with information regarding said community association;
transferring at least a subset of said information to a handheld computing device;
conducting a physical inspection of structures belonging to said community association for compliance with said regulations; and
recording the result of said inspection in said handheld computing device.

2. The method of claim 1 wherein said information regarding said community association includes the location of said structures.

3. The method of claim 2 wherein said information regarding said community association includes the names and addresses of persons or entities responsible for said structures being in compliance with said regulations.

4. The method of claim 3 wherein said information regarding said community association includes the names and addresses of persons or entities available to perform repairs to bring said structures into compliance with said regulations.

5. The method of claim 4 wherein said information regarding said community association includes previously recorded results of inspections of said structures.

6. The method of claim 5 wherein said information regarding said community association includes a text version of said regulations.

7. The method of claim 6 wherein said structures are selected from among the group comprised of: privately owned buildings, commonly owned buildings, roads, sidewalks, and combinations thereof.

8. The method of claim 7 further comprising the step of transferring said inspection results to said database from said handheld computing device.

9. The method of claim 8 wherein said handheld computing device is a PDA.

10. The method of claim 9 wherein said step of transferring said inspection results to said database from said handheld computing device comprises the electronic synchronization of said PDA with said database.

11. The method of claim 8 further comprising the step of automatically generating documents containing information regarding said community association.

12. The method of claim 1 wherein said documents are letters notifying said persons or entities responsible for said structures being in compliance with said regulations of said inspection results.

13. The method of claim 11 wherein said documents are reports including information regarding said inspection results.

14. The method of claim 11 wherein said documents are work orders to said persons or entities available to perform repairs to bring said structures into compliance with said regulations.

15. The method of claim 11 wherein said documents are web pages.

16. The method of claim 1 wherein said handheld computing device is a PDA.

17. The method of claim 16 wherein said step of transferring at least a subset of said information to a handheld computing device comprises the electronic synchronization of said PDA with said database.

18. The method of claim 1 wherein said recorded result of said inspection includes media selected from the group comprised of: digital textual descriptions, digital photographs; digitized voice descriptions, and combinations thereof.

19. A computer-implemented method for tracking and processing violations of regulations of a plurality of community associations comprising the steps of:
populating a database with information regarding said plurality of community associations;
selecting information pertaining to a single community association from said information regarding said plurality of community associations;
transferring at least a subset of said selected information to a handheld computing device;
conducting a physical inspection of structures belonging to said single community association for compliance with said regulations; and
recording the result of said inspection in said handheld computing device.

20. The method of claim 19 wherein said selected information includes the location of said structures.

21. The method of claim 19 wherein said selected information includes the names and addresses of persons or entities responsible for said structures being in compliance with said regulations.

22. The method of claim 20 wherein said selected information includes the names and addresses of persons or entities available to perform repairs to bring said structures into compliance with said regulations.

23. The method of claim 21 wherein said selected information includes previously recorded results of inspections of said structures.

24. The method of claim 23 wherein said selected information includes a text version of said regulations.

25. The method of claim 24 wherein said structures are selected from among the group comprised of: privately owned buildings, commonly owned buildings, roads, sidewalks, and combinations thereof.

26. The method of claim 25 further comprising the step of transferring said inspection results to said database from said handheld computing device.

27. The method of claim 26 wherein said handheld computing device is a PDA.

28. The method of claim 27 wherein said step of transferring said inspection results to said database from said handheld computing device comprises the electronic synchronization of said PDA with said database.

29. The method of claim 26 further comprising the step of automatically generating documents containing information regarding said plurality of community associations.

30. The method of claim 29 wherein said documents are letters notifying said persons or entities responsible for said structures being in compliance with said regulations of said inspection results.

31. The method of claim 29 wherein said documents are reports including information regarding said inspection results.

32. The method of claim 29 wherein said documents are work orders to said persons or entities available to perform repairs to bring said structures into compliance with said regulations.

33. The method of claim 29 wherein said documents are web pages.

34. The method of claim 19 wherein said handheld computing device is a PDA.

35. The method of claim 34 wherein said step of transferring at least a subset of said information to a handheld computing device comprises the electronic synchronization of said PDA with said database.

36. The method of claim 19 wherein said recorded result of said inspection includes media selected from the group comprised of: digital textual descriptions, digital photographs; digitized voice descriptions, and combinations thereof.

37. A system for tracking and processing violations of regulations of a community association comprising:
a database server including a database populated with information regarding said community association;
a handheld computing device;
synchronization hardware for transferring data between said handheld computing device and said database server;
computer software means for selectively transferring at least a subset of said information regarding said community association from said database to said handheld computing device;
computer software means for displaying said subset of said information regarding said community association on said handheld computing device while conducting a physical inspection of structures belonging to said community association for compliance with said regulations; and
computer software means for recording the result of said inspection in said handheld computing device.

38. The system of claim 37 wherein said information regarding said community association includes the location of said structures.

39. The system of claim 38 wherein said information regarding said community association includes the names and addresses of persons or entities responsible for said structures being in compliance with said regulations.

40. The system of claim 39 wherein said information regarding said community association includes the names and addresses of persons or entities available to perform repairs to bring said structures into compliance with said regulations.

41. The system of claim 40 wherein said information regarding said community association includes previously recorded results of inspections of said structures.

42. The system of claim 41 wherein said information regarding said community association includes a text version of said regulations.

43. The system of claim 42 wherein said structures are selected from among the group comprised of: privately owned buildings, commonly owned buildings, roads, sidewalks, and combinations thereof.

44. The system of claim 43 further comprising computer software means for transferring said result of said inspection to said database from said handheld computing device.

45. The system of claim 44 wherein said handheld computing device is a PDA.

46. The system of claim 37 wherein said synchronization hardware for transferring data between said handheld computing device and said database server is a docking station.

47. The system of claim 44 further comprising computer software means for automatically generating documents containing information regarding said community association.

48. The system of claim 47 wherein said documents are letters notifying said persons or entities responsible for said structures being in compliance with said regulations of said inspection results.

49. The system of claim 47 wherein said documents are reports including information regarding said inspection results.

50. The system of claim 47 wherein said documents are work orders to said persons or entities available to perform repairs to bring said structures into compliance with said regulations.

51. The system of claim 47 wherein said documents are web pages.

52. The system of claim 37 wherein said handheld computing device is a PDA.

53. The system of claim 52 wherein said synchronization hardware for transferring data between said handheld computing device and said database server is a docking station.

54. The system of claim 37 wherein said recorded result of said inspection includes media selected from the group comprised of: digital textual descriptions, digital photographs; digitized voice descriptions, and combinations thereof.
